(19) United States
(12) Patent Application Publication
(10) Pub. No.: US 2013/0285863 A1
(43) Pub. Date: Oct. 31, 2013

(54) Reconfigurable Multi-band Antenna

(71) Applicants: Javier Rodriguez De Luis, Kirkland, WA (US); Alireza Mahanfar, Redmond, WA (US); Benjamin J. Shewan, Redmond, WA (US); Stanley Yu Tao Ng, Bellevue, WA (US)

(72) Inventors: Javier Rodriguez De Luis, Kirkland, WA (US); Alireza Mahanfar, Redmond, WA (US); Benjamin J. Shewan, Redmond, WA (US); Stanley Yu Tao Ng, Bellevue, WA (US)

(73) Assignee: MICROSOFT CORPORATION, Redmond, WA (US)

(21) Appl. No.: 13/456,931

(22) Filed: Apr. 26, 2012

(51) Int. Cl. H01Q 5/00

(52) U.S. Cl. 343/745

(57) ABSTRACT

Reconfigurable multi-band antenna techniques are described. In one or more implementations, an apparatus includes an antenna that can operate at multiple frequency bands that include first and second frequency bands, respectively. The antenna includes a first radiator structure configured to tune to the first frequency band and comprising a first radiator element. In addition, the antenna includes a second radiator structure configured to tune to the second frequency band and comprising the first radiator element and a second radiator element. The antenna also includes a tunable circuit configured to couple the first radiator element to the second radiator element. Additionally, the apparatus includes a communication module configured to use the tunable circuit to adjust one of said first and second frequency bands independently from, and without causing a change in, the other of said first and second frequency bands.

### BACKGROUND

The functionality that is provided by devices, including mobile devices, is ever increasing. For example, mobile devices such as telephones were initially configured to simply operate as a telephone. Functionality was then added to include processors capable of executing applications on the device itself, maintain calendars, provide a variety of different messaging techniques (e.g., email, SMS, MMS, instant messaging), and so on.

Consequently, the mobile device may be configured to support a variety of different communication techniques that use different frequency bands. Examples include a telephone network to engage in a wide area network wireless connection as well as local area network wireless connection, such as through one or more standards in compliance with IEEE 802.11.

Traditional techniques that were utilized to support this wireless communication, however, relied on separate antennas that were specifically tuned to support a particular frequency band. Thus, design of the mobile device may be constrained using traditional techniques that involved inclusion of a separate antenna for each group of the frequency bands supported by the device.

### SUMMARY

Reconfigurable multi-band antenna techniques are described. In one or more implementations, an apparatus includes an antenna that can generate multiple frequency bands that include first and second frequency bands, respectively. The antenna includes a first radiator structure configured to tune to the first frequency band and comprising a first radiator element. In addition, the antenna includes a second radiator structure configured to tune to the second frequency band and comprising the first radiator element and a second radiator element. The antenna also includes a tunable circuit configured to couple the first radiator element to the second radiator element. Additionally, the apparatus includes a communication module configured to use the tunable circuit to adjust one of the first and second frequency bands independently from, and without causing a change in, the other of said first and second frequency bands.

In one or more implementations, a device includes an antenna and a communication module. The antenna includes multiple radiators coupled together by at least one resonator circuit, the antenna configured to generate multiple frequencies simultaneously. In addition, the communication module is configured to tune one of the multiple frequencies independently of another of the multiple frequencies by using the at least one resonator circuit.

In one or more implementations, a dual frequency band is operated by an antenna that includes at least two radiator elements coupled together by a tunable circuit. In addition, one or more circuit element values of the tunable circuit are adjusted to tune at least one frequency in the dual frequency band. In response to the adjustment, at least one frequency in the dual frequency band is tuned independently of another frequency in the dual frequency band.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items. Entities represented in the figures may be indicative of one or more entities and thus reference may be made interchangeably to single or plural forms of the entities in the discussion.

FIG. 1 is an illustration of an environment in an example implementation that is operable to employ reconfigurable multi-band antenna techniques described herein.

FIG. 2 is an illustration of a system in an example implementation showing an antenna of FIG. 1 in greater detail.

FIGS. 3a-d depict a system in various example implementations showing a tunable circuit of FIG. 2 in greater detail.

FIG. 4 is a chart in an example implementation showing tunable frequencies in an example dual band frequency.

FIG. 5 is a flow diagram depicting a procedure in an example implementation in which a tunable circuit is used to tune to different frequency bands in a dual frequency band independently of one another.

FIG. 6 illustrates an example system that includes a device as described with reference to FIG. 1.

FIG. 7 illustrates various components of an example device that can be implemented as any type of device as described with reference to FIGS. 1, 2, and 6 to implement embodiments of the techniques described herein.

### DETAILED DESCRIPTION

### Overview

Features are continually added to devices which may complicate configuration of the device, especially for mobile use. One such example is the continued expansion of wireless signal techniques and frequency bands that may be incorporated by the device, such as to communicate with another device. Recent techniques allow certain frequencies to coexist with legacy bands with minimal interference. These techniques conventionally involved use of a separate antenna for each frequency range that was to be supported by the device, such as to support local and wide area wireless networks, or to support multiple coexisting frequency bands. Switches were typically used to connect or disconnect different antenna branches or sections, but the number of bands where the antenna was capable of operating was limited by the number of switching states. Consequently, design of devices that were to support multiple wireless signal techniques may be constrained by the antennas used by these techniques.

Reconfigurable multi-band antennas are described. In one or more implementations, an antenna may be designed to support multiple different wireless frequency bands, with functionality to tune between the different bands. These techniques may include one or more wireless communication techniques, such as cellular communications (e.g. 2G/3G/4G), near field communication (NFC), short-range wireless connections (e.g., Bluetooth), local area wireless networks (e.g., one or more standards in compliance with IEEE 802.11), wide area wireless networks (e.g., one or more standard in compliance with IEEE 802.16, wireless telephone networks), and so on.

In one example, the antenna is configured to support dynamic tuning of a fixed radiating structure. For example, the antenna may include a fixed radiating structure formed as a single branch that is configured to use resonators coupled by a tunable circuit to support different frequency bands. Thus, the antenna may be configured without use of switches and/or multiple arms that were conventionally used to change the radiating structure, which were complex, had a high demand on antenna volume, and provided limited support of different bands. Further discussion of reconfigurable multi-band antennas may be found in relation to the following sections.

In the following discussion, an example environments are first described that may employ the techniques described herein. Example procedures are then described which may be performed in the example environments as well as other environments. Consequently, performance of the example procedures is not limited to the example environments and the example environments are not limited to performance of the example procedures.

### Example Environment

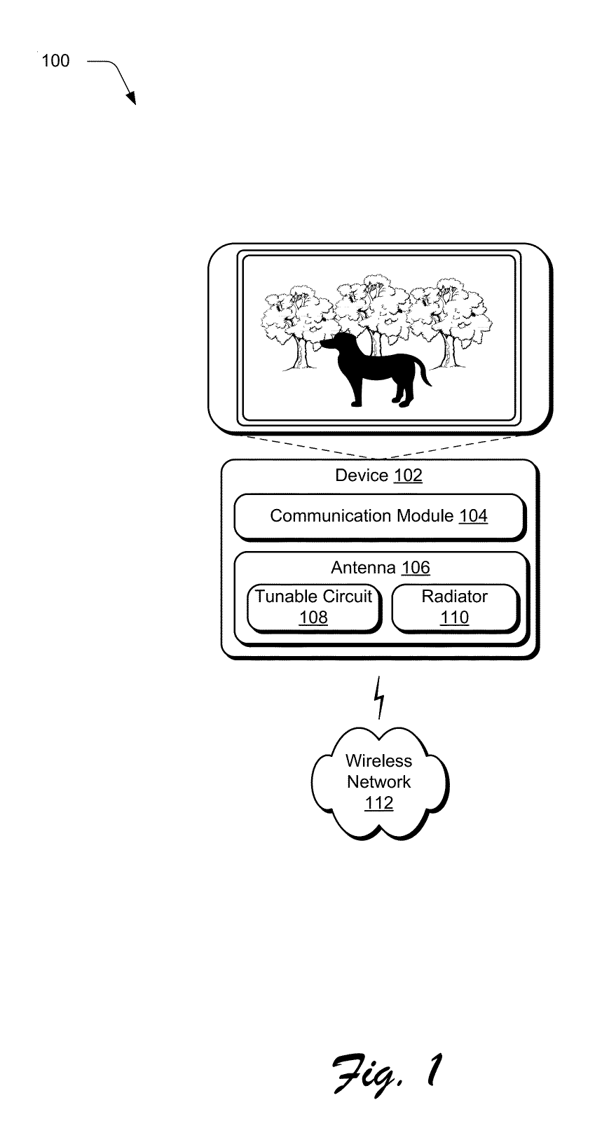

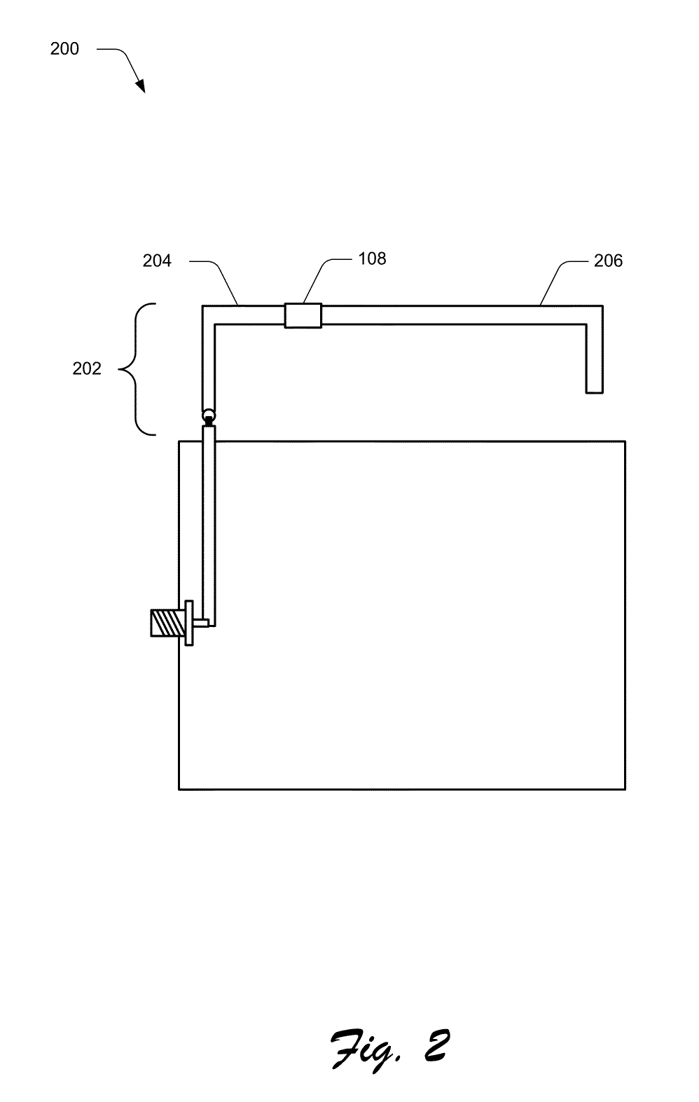

FIG. 1 is an illustration of an environment 100 in an example implementation that is operable to employ reconfigurable multi-band antenna techniques described herein. The illustrated environment 100 includes a device 102, which may be configured as an electrical device that includes a communication module 104 and an antenna 106, which are communicatively coupled to each other. The antenna 106 may be configured to support multi-band operation by utilizing a tunable circuit 108 and one or more radiators 110.

Although the device 102 is illustrated as a mobile device (e.g., a mobile communications device such as a wireless phone or tablet computer), the device 102 may assume a wide variety of configurations. For example, the device 102 may be configured as a computing device such as a computer that is capable of wireless communication, such as a desktop computer, a mobile station, an entertainment appliance, a set-top box communicatively coupled to a display device, a wireless phone, a game console, and so forth. The device 102 may also assume a variety of other electrical configurations, such as a portable device such as a game controller, remote control device, input/output device, peripheral device, and so on.

Thus, the device 102 may range from full resource devices with substantial resources (e.g., personal computers, game consoles) to a low-resource device with limited resources (e.g., remote controls for televisions, game controller, and so forth). Additionally, although a single device 102 is shown, the device 102 may be representative of a plurality of different devices, such as a remote control and set-top box combination, a game controller and game console, and so on.

The device is illustrated as including a communication module 104. The communication module 104 is representative of functionality of the device 102 to employ one or more wireless communication techniques, such as to communicate via a wireless network 112 with another communication device. The communication module 104, for instance, may be configured to tune one or more frequency bands in the multi-band operation provided by the antenna 106. These wireless communication techniques may be configured in a variety of different ways, such as to support near field communication (NFC), short range wireless communication (e.g., Bluetooth), local area wireless networks (e.g., one or more standards in compliance with IEEE 802.11), wide area wireless networks (e.g., one or more standards in compliance with IEEE 802.16, wireless telephone networks including 3G, 4G, LTE, GSM, CDMA), and so forth.

For example, the communication module 104 may be configured to employ the antenna 106 to send and/or receive signals communicated via the wireless network 112 with one or more other devices. In one or more implementations described herein, the communication module 104 may employ the antenna 106 for a plurality of different wireless communication techniques, e.g., techniques that involve different frequency ranges as described above. Thus, a single antenna 106 may be employed by the device 102, thereby expanding configuration options of the device 102 over conventional techniques that involved a separate antenna for each technique or each different frequency range.

In one or more implementations, the antenna 106 may be configured to support multiband operation by, for example, using at least two radiators 110 coupled by the tunable circuit 108 to form a single radiator branch. The tunable circuit 108 in the antenna 106 may be used to dynamically change each frequency in the multiband independently of one another.

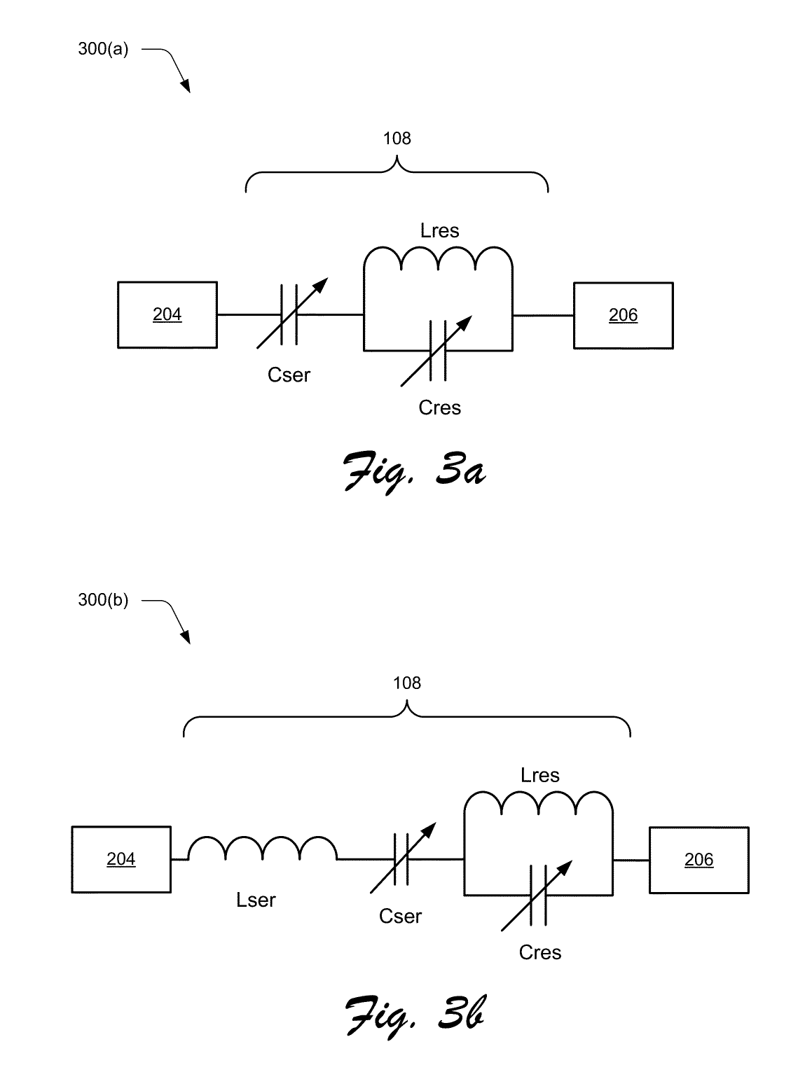

Thus, the device 102 may employ the antenna 106 for multiband operation and adjust one or more of the frequencies on demand in order to improve wireless communications with other devices. In this way, a single branch of an antenna 106 may support multiple frequency bands and continuous band tenability, such as the ability to dynamically tune each of the frequencies without the use of additional arms and without changing a volume of the antenna, further discussion of which may be found in relation to FIG. 2.

Generally, any of the functions described herein can be implemented using software, firmware, hardware (e.g., fixed logic circuitry), or a combination of these implementations. The terms “module,” “functionality,” and “logic” as used herein generally represent software, firmware, hardware, or a combination thereof. In the case of a software implementation, the module, functionality, or logic represents program code that performs specified tasks when executed on a processor (e.g., CPU or CPUs). The program code can be stored in one or more computer readable memory devices. The features of the techniques described below are platform-independent, meaning that the techniques may be implemented on a variety of commercial computing platforms having a variety of processors.

The device 102 may also include an entity (e.g., software) that causes hardware of the device 102 to perform operations, e.g., processors, functional blocks, and so on. For example, the device 102 may include a computer-readable medium that may be configured to maintain instructions that cause the computing device, and more particularly hardware of the device 102 to perform operations. Thus, the instructions function to configure the hardware to perform the operations and in this way result in transformation of the hardware to perform functions. The instructions may be provided by the computer-readable medium to the device 102 through a variety of different configurations.

One such configuration of a computer-readable medium is signal bearing medium and thus is configured to transmit the instructions (e.g., as a carrier wave) to the hardware of the computing device, such as via a network. The computer-readable medium may also be configured as a computer-readable storage medium and thus is not a signal bearing medium. Examples of a computer-readable storage medium include a random-access memory (RAM), read-only memory (ROM), an optical disc, flash memory, hard disk memory, and other memory devices that may use magnetic, optical, and other techniques to store instructions and other data.

FIG. 2 is an illustration of a system 200 in an example implementation showing the antenna 106 of FIG. 1 in greater detail. The antenna 106 in this example is illustrated as including a single fixed radiating structure 202. The fixed radiating structure 202 may be configured in a variety of ways, such as to transmit or receive a wireless signal, generate multiple frequency bands, and so on. The fixed radiating structure 202 is fixed in that it does not change its physical characteristics, e.g., such as through the use of switches or inclusion of multiple arms as was conventionally performed. For purposes of simplicity and ease of explanation, the radiating structure 202 in this example is illustrated as including a single antenna branch formed by two radiators 204, 206 and a tunable circuit 108. However, other embodiments are also contemplated in which the antenna 106 may utilize multiple tunable circuits to couple multiple radiators together to form a single antenna branch configured to support multiple band operation such as tri-band, quad-band, penta-band, and so on.

In the illustrated example, by locating the tunable circuit 108 on the single radiating structure 202, the antenna 106 may employ the tunable circuit 108 to generate a dual band, such as a legacy band coexisting with an additional frequency band. For instance, the antenna may use one or both of the radiators 204, 206 to generate different frequencies. Further, the tunable circuit 108 may be employed to tune one or both of the frequencies in the dual band independently of the other frequency. Thus a single radiating structure 202 may be employed by the antenna 106 to support different wireless signal techniques without adding or subtracting different branches or changing a volume of the antenna.

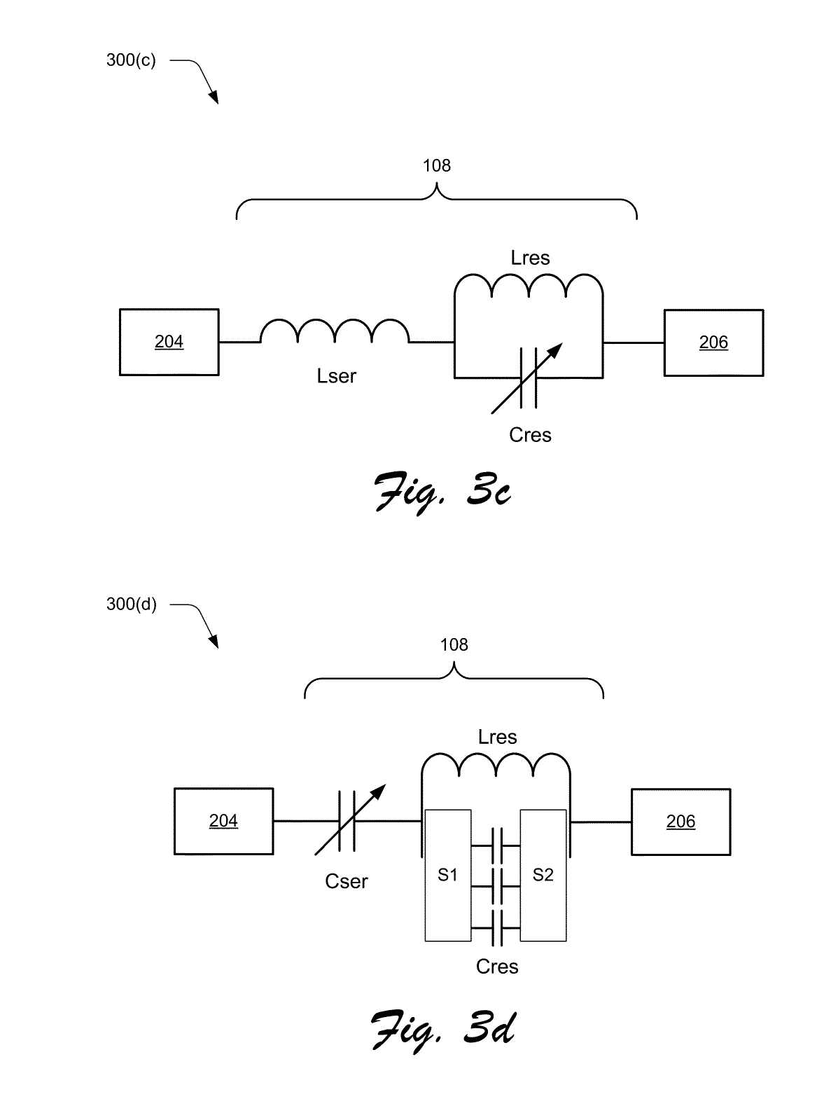

In implementations, the radiators included in the antenna 106 may have different lengths, such as physical or electrical lengths. Different lengths of antenna branches can be used to operate at different frequencies. For instance, shorter and longer antenna branches operate at higher and lower frequencies, respectively. In the example system 200, radiator 204 may be shorter in length than radiator 206. In this way, current flowing in a shorter radiator 204 may create an antenna with a high resonance frequency. The current flowing through radiators 204 and 206, however, will generate a low resonance frequency relative to the high resonance frequency generated by the shorter radiator 204. Further discussion of this can be found in relation to FIGS. 3a-d.

FIGS. 3a-d depict a system 300(a)-(d) in various example implementations showing the tunable circuit 108 of FIG. 2 in greater detail. In the example implementation shown in FIG. 3a, the tunable circuit 108 may include a parallel inductor-capacitor (LC) tank, illustrated as Lres and Cres, connected in series with a capacitor Cser so as to form a series resonator with Cser and Lres. The LC tank is configured to form a first resonator (e.g., parallel resonator). At a resonance frequency created by the LC tank, the tunable circuit 108 may have a high impedance behavior, which may cause a majority of current to be constrained to flow in radiator 204. In this way, the current constrained in radiator 204 may be used to generate a high frequency band due to the relatively short length of the radiator 204.

At low frequencies (e.g., frequencies lower than the high resonance frequency created by the LC tank), excess reactance of the LC tank has an inductive behavior. The equivalent inductor Lres in series with Cser creates a second resonator (e.g., the series resonator). At a certain frequency, the series resonator presents a low impedance behavior, allowing the current to flow in both radiators 204 and 206, and generating an antenna with a low resonance frequency that is lower than the high resonance frequency created by the LC tank. Other configurations of series resonators and parallel resonators are also contemplated and may operate similarly to the example implementation described in FIG. 3a.

For instance, FIG. 3b illustrates an example implementation including the LC tank in series with both the series capacitor Cser and a second inductor Lser. Alternatively, as shown in FIG. 3c, the tunable circuit may include the parallel resonator (e.g., LC tank) in series with a second inductor Lser, without a series capacitor. Another implementation, shown in FIG. 3d, may include the LC tank having one or more switches S1 and/or S2 that may be configured to adjust a capacitance of the LC tank by selecting one or more parallel capacitors Cres to operate in parallel with the inductor Lres. Alternatively or additionally, the switches may be configured to select one or more inductors or a combination of inductors and capacitors in the LC tank.

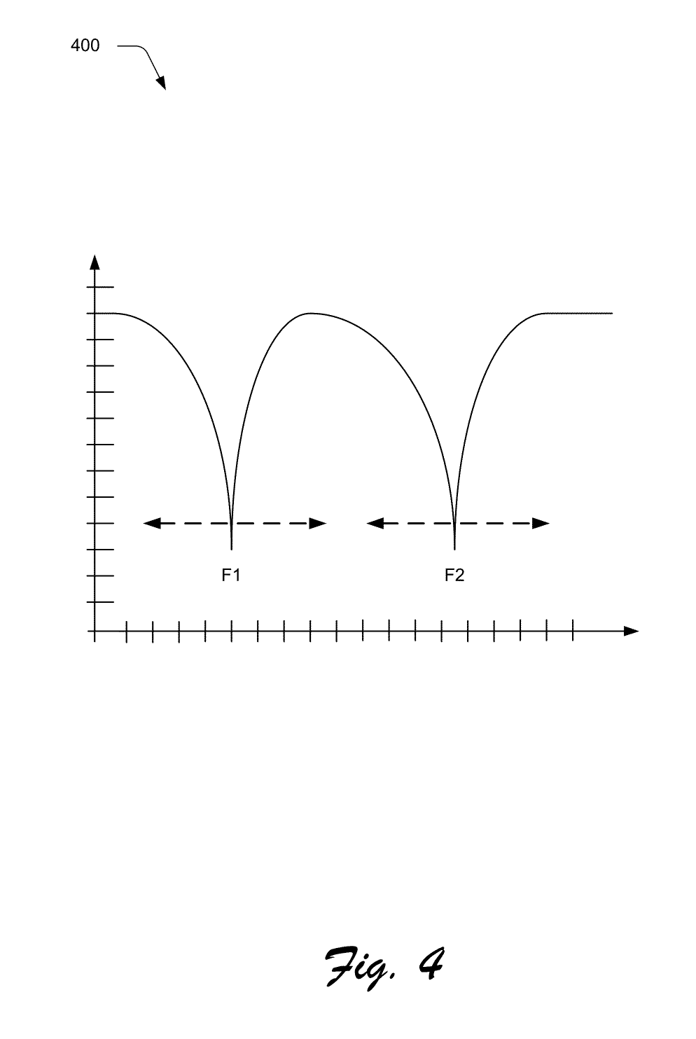

By including the LC tank and the series resonator in the tunable circuit 108 as described above, dual banding may be accomplished. In addition, the capacitors and the inductors used in the tunable circuit 108 are reconfigurable to dynamically tune each of the different frequencies independently. An example of this is shown in FIG. 4, which illustrates a chart 400 with a dual band frequency that includes a low resonance frequency F1 and a high resonance frequency F2 generated by the antenna described above. In implementations, the low resonance frequency F1 may be increased or decreased by changing a value of the capacitor Cser, and/or the inductor Lser, in the series resonator. Alternatively or additionally, the high resonance frequency F2 may be increased or decreased by changing a value of the capacitor Cres, and/or the inductor Lres, in the parallel resonator (e.g., the LC tank). In implementations, both F1 and F2 can be tuned independently.

In implementations, changing the value of Cser, or Lser, in the series resonator may cause a change in F1, but may not cause a significant change in F2. Likewise, increasing or decreasing the value of Cres, or Lres, in the parallel resonator may cause a change in F2, while allowing F1 to remain nearly constant. In both of these instances, when one of the frequencies is tuned, radiated performance of either frequency is not degraded.

The structure of the antenna 106 therefore provides for dynamic tuning of each band in a multiband operation independently of one another without using additional arms or switches as was conventionally used. Also, because of the relative placement of the tunable circuit 108 in the radiator structure 202, the current may flow on demand, and antenna performance for the different frequency bands to which the antenna is tuned is not degraded. In effect, this decreases antenna volume compared with traditional techniques, particularly for mobile devices, mitigates user effects on the antenna by adding a re-tuning ability, and increases radiation performance for the antenna at each operating band. Further discussion of these and other techniques may be found in relation to the following procedure.

### Example Procedure

The following discussion describes reconfigurable multi-band antenna techniques that may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference will be made to the environment 100 of FIG. 1 and the systems 200, 300 of FIGS. 2 and 3, respectively.

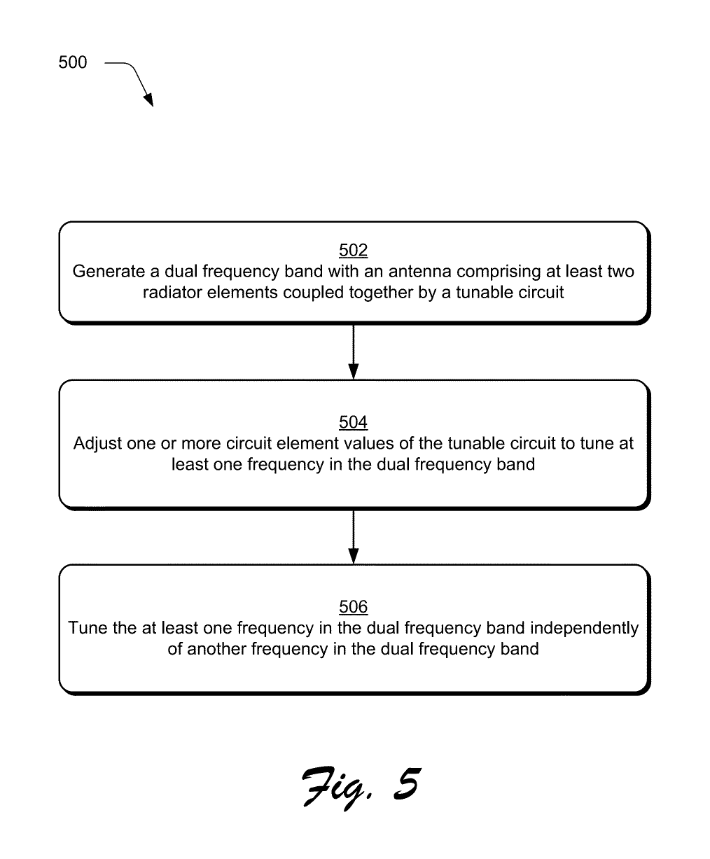

FIG. 5 depicts a procedure 500 in an example implementation in which a tunable circuit is used to tune to different frequency bands in a dual frequency band independently of one another. A dual frequency band is generated with an antenna comprising at least two radiator elements coupled together by a tunable circuit (block 502). For example, a first radiator element, such as radiator 204, may be used to generate a first frequency (e.g., a high frequency) by allowing current to flow through the first radiator element. In addition, a second radiator element, such as radiator 206, may be used in conjunction with the first radiator element to generate a second frequency (e.g., a low frequency) by allowing current to flow through the second radiator element via the first radiator and the tunable circuit 108. In this way, two different frequencies in a dual frequency band can be generated by the antenna.

One or more circuit element values of the tunable circuit are adjusted to tune at least one frequency in the dual frequency band (block 504). Continuing with the previous example, tunable circuit may include a parallel resonator connected in series with a capacitor, where the parallel resonator includes an inductor connected in parallel with a second capacitor. By adjusting a value of the capacitor in series with the parallel resonator, a low frequency in the dual frequency band can be tuned. Also, by adjusting a value of the capacitor in parallel with the inductor, a high frequency in the dual frequency band can be tuned. Alternatively or additionally, a value of the inductor may be adjusted to tune one of the frequencies in the dual frequency band.

At least one frequency in the dual frequency band is tuned independently of another frequency in the dual frequency band (block 506). Continuing with the previous example, tuning one of the frequencies in the dual frequency band may not affect a change in radiated performance of the other frequency in the dual frequency band. For instance, adjusting the value of the capacitor in series with the parallel resonator may tune the high frequency, but the low frequency may remain unaffected. In addition, adjusting the value of the capacitor in the parallel resonator may tune the low frequency, but the high frequency may remain unaffected. In this way, performance of the antenna is not degraded when one or more of the frequencies in the dual frequency band are tuned.

### Example System and Device

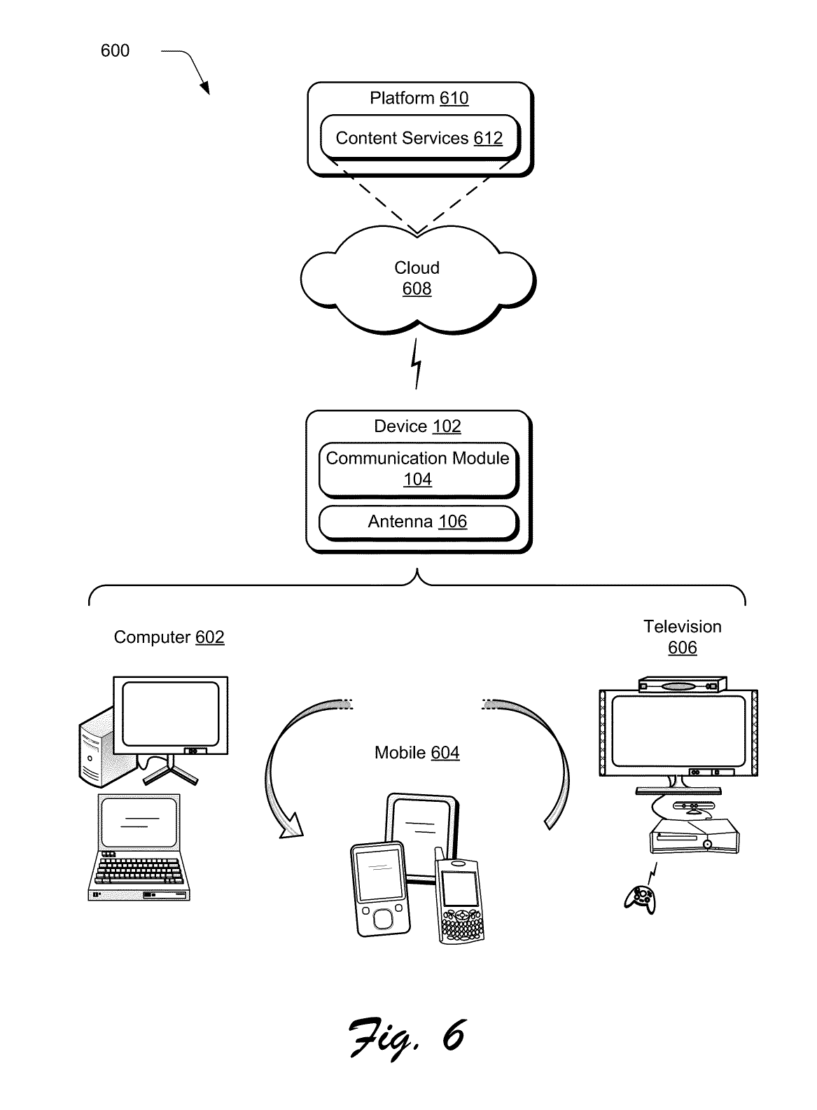

FIG. 6 illustrates an example system 600 that includes the device 102 as described with reference to FIG. 1 as well as the communication module 104 and antenna 106. The example system 600 enables ubiquitous environments for a seamless user experience when running applications on a personal computer (PC), a television device, and/or a mobile device. Services and applications run substantially similar in all three environments for a common user experience when transitioning from one device to the next while utilizing an application, playing a video game, watching a video, and so on.

In the example system 600, multiple devices are interconnected through a central computing device. The central computing device may be local to the multiple devices or may be located remotely from the multiple devices. In one embodiment, the central computing device may be a cloud of one or more server computers that are connected to the multiple devices through a network, the Internet, or other data communication link. In one embodiment, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one embodiment, a class of target devices is created and experiences are tailored to the generic class of devices. A class of devices may be defined by physical features, types of usage, or other common characteristics of the devices.

In various implementations, the computing device 102 may assume a variety of different configurations, such as for computer 602, mobile 604, and television 606 uses. Each of these configurations includes devices that may have generally different constructs and capabilities, and thus the computing device 102 may be configured according to one or more of the different device classes. For instance, the computing device 102 may be implemented as the computer 602 class of a device that includes a personal computer, desktop computer, a multi-screen computer, laptop computer, netbook, and so on.

The computing device 102 may also be implemented as the mobile 604 class of device that includes mobile devices, such as a mobile phone, portable music player, portable gaming device, a tablet computer, a multi-screen computer, and so on. The computing device 102 may also be implemented as the television 606 class of device that includes devices having or connected to generally larger screens in casual viewing environments. These devices include televisions, set-top boxes, gaming consoles, and so on. The techniques described herein may be supported by these various configurations of the computing device 102 and are not limited to the specific examples the techniques described herein.

The cloud 608 includes and/or is representative of a platform 610 for content services 612. The platform 610 abstracts underlying functionality of hardware (e.g., servers) and software resources of the cloud 608. The content services 612 may include applications and/or data that can be utilized while computer processing is executed on servers that are remote from the computing device 102. Content services 612 can be provided as a service over the Internet and/or through a subscriber network, such as a cellular or Wi-Fi network.

The platform 610 may abstract resources and functions to connect the computing device 102 with other computing devices. The platform 610 may also serve to abstract scaling of resources to provide a corresponding level of scale to encountered demand for the content services 612 that are implemented via the platform 610. Accordingly, in an interconnected device embodiment, implementation of functionality of the functionality described herein may be distributed throughout the system 600. For example, the functionality may be implemented in part on the computing device 102 as well as via the platform 610 that abstracts the functionality of the cloud 608.

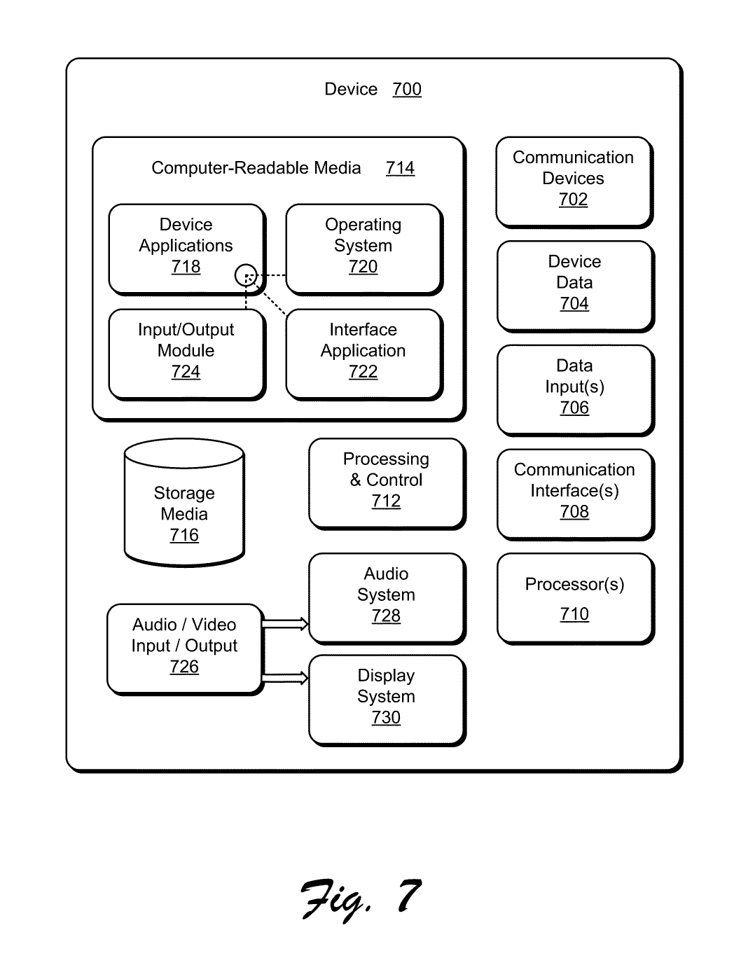

FIG. 7 illustrates various components of an example device 700 that can be implemented as any type of computing device as described with reference to FIGS. 1 and 6 to implement embodiments of the techniques described herein. Device 700 includes communication devices 702 that enable wired and/or wireless communication of device data 704 (e.g., received data, data that is being received, data scheduled for broadcast, data packets of the data, etc.). The device data 704 or other device content can include configuration settings of the device, media content stored on the device, and/or information associated with a user of the device. Media content stored on device 700 can include any type of audio, video, and/or image data. Device 700 includes one or more data inputs 706 via which any type of data, media content, and/or inputs can be received, such as user-selectable inputs, messages, music, television media content, recorded video content, and any other type of audio, video, and/or image data received from any content and/or data source.

Device 700 also includes communication interfaces 708 that can be implemented as any one or more of a serial and/or parallel interface, a wireless interface (and thus may include the antenna 106 of FIG. 1), any type of network interface, a modem, and as any other type of communication interface. The communication interfaces 708 provide a connection and/or communication links between device 700 and a communication network by which other electronic, computing, and communication devices communicate data with device 700.

Device 700 includes one or more processors 710 (e.g., any of microprocessors, controllers, and the like) which process various computer-executable instructions to control the operation of device 700 and to implement embodiments of the techniques described herein. Alternatively or in addition, device 700 can be implemented with any one or combination of hardware, firmware, or fixed logic circuitry that is implemented in connection with processing and control circuits which are generally identified at 712. Although not shown, device 700 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

Device 700 also includes computer-readable media 714, such as one or more memory components, examples of which include random access memory (RAM), non-volatile memory (e.g., any one or more of a read-only memory (ROM), flash memory, EPROM, EEPROM, etc.), and a disk storage device. A disk storage device may be implemented as any type of magnetic or optical storage device, such as a hard disk drive, a recordable and/or rewriteable compact disc (CD), any type of a digital versatile disc (DVD), and the like. Device 700 can also include a mass storage media device 716.

Computer-readable media 714 provides data storage mechanisms to store the device data 704, as well as various device applications 718 and any other types of information and/or data related to operational aspects of device 700. For example, an operating system 720 can be maintained as a computer application with the computer-readable media 714 and executed on processors 710. The device applications 718 can include a device manager (e.g., a control application, software application, signal processing and control module, code that is native to a particular device, a hardware abstraction layer for a particular device, etc.). The device applications 718 also include any system components or modules to implement embodiments of the techniques described herein. In this example, the device applications 718 include an interface application 722 and an input/output module 724 that are shown as software modules and/or computer applications. The input/output module 724 is representative of software that is used to provide an interface with a device configured to capture inputs, such as a touchscreen, track pad, camera, microphone, and so on. Alternatively or in addition, the interface application 722 and the input/output module 724 can be implemented as hardware, software, firmware, or any combination thereof. Additionally, the input/output module 724 may be configured to support multiple input devices, such as separate devices to capture visual and audio inputs, respectively.

Device 700 also includes an audio and/or video input-output system 726 that provides audio data to an audio system 728 and/or provides video data to a display system 730. The audio system 728 and/or the display system 730 can include any devices that process, display, and/or otherwise render audio, video, and image data. Video signals and audio signals can be communicated from device 700 to an audio device and/or to a display device via an RF (radio frequency) link, S-video link, composite video link, component video link, DVI (digital video interface), analog audio connection, or other similar communication link. In an embodiment, the audio system 728 and/or the display system 730 are implemented as external components to device 700. Alternatively, the audio system 728 and/or the display system 730 are implemented as integrated components of example device 700.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. An apparatus comprising:
an antenna configured to generate multiple frequency bands comprising first and second frequency bands, respectively, the antenna including:
a first radiator structure configured to tune to the first frequency band and comprising a first radiator element;
a second radiator structure configured to tune to the second frequency band and comprising the first radiator element and a second radiator element; and
a tunable circuit configured to couple the first radiator element to the second radiator element; and
a communication module configured to use the tunable circuit to adjust one of said first and second frequency bands independently from, and without causing a change in, the other of said first and second frequency bands.

2. An apparatus as recited in claim 1, wherein the first radiator structure is configured to operate within a first frequency range that is different than a second frequency range within which the second radiator structure is configured to operate.

3. An apparatus as recited in claim 1, wherein the tunable circuit comprises a resonator circuit having a parallel resonator connected in series with a capacitor, the parallel resonator including a second capacitor connected in parallel with an inductor.

4. An apparatus as recited in claim 3, wherein:
both the capacitor and the second capacitor are tunable; and
the inductor is tunable effective to adjust one of said first or second frequency bands.

5. An apparatus as recited in claim 1, wherein the tunable circuit includes a parallel inductor-capacitor (LC) tank and a series resonator, the parallel LC tank including a capacitor connected in parallel with an inductor, the series resonator comprising a second capacitor connected in series with an excess reactance of the first resonator, the excess reactance having an inductive behavior.

6. An apparatus as recited in claim 5, wherein the communication module is further configured to tune a high frequency resonance by changing a value of the capacitor in the LC tank.

7. An apparatus as recited in claim 5, wherein the communication module is further configured to tune a low frequency resonance by changing a value of the second capacitor in the series resonator.

8. An apparatus as recited in claim 5, wherein the tunable circuit is further configured to generate a lower resonance frequency by allowing current to flow in both the first and second said radiator structures based on the series resonator.

9. An apparatus as recited in claim 5, wherein the parallel LC tank is configured to cause a high impedance effective to cause a majority of current flowing through the antenna to flow in the first radiator structure and not in the second radiator structure.

10. An apparatus as recited in claim 1, wherein the first radiator structure comprises a length that is shorter than a length of the second radiator structure.

11. An apparatus as recited in claim 1, wherein the multiple frequency bands include first and second sets of frequency bands, wherein the first radiator structure is configured to tune to the first set of frequency bands, wherein the second radiator structure is configured to tune to the second set of frequency bands.

12. A device comprising:
an antenna including multiple radiators coupled together by at least one resonator circuit, the antenna configured to generate multiple frequencies simultaneously; and
a communication module configured to tune one of the multiple frequencies independently of another of the multiple frequencies by using the at least one resonator circuit.

13. A device as recited in claim 12, wherein the at least one resonator circuit includes a parallel resonator connected in series with a series capacitor, the parallel resonator including a second capacitor connected in parallel with an inductor.

14. A device as recited in claim 13, wherein both the series capacitor and the second capacitor are tunable.

15. A device as recited in claim 13, wherein both the inductor and the series capacitor are tunable.

16. A device as recited in claim 13, further comprising one or more switches configured to select a value of the inductor or the second capacitor in the parallel resonator to tune a low frequency resonance, the one or more switches being further configured to select a value of the series capacitor that is connected in series with the parallel resonator.

17. A device as recited in claim 13, wherein the communication module is further configured to tune a high frequency resonance by changing a value of the second capacitor in the parallel resonator or a value of the inductor in the parallel resonator.

18. A device as recited in claim 13, wherein the communication module is further configured to tune a low frequency resonance by changing a value of the capacitor in series with the parallel resonator.

19. A method comprising:
operating at dual frequency band with an antenna comprising at least two radiator elements coupled together by a tunable circuit;
adjusting one or more circuit element values of the tunable circuit to tune at least one frequency in the dual frequency band; and
responsive to the adjusting, tuning the at least one frequency in the dual frequency band independently of another frequency in the dual frequency band.

20. A method as recited in claim 19, wherein adjusting the one or more circuit element values comprises:
adjusting a first capacitor or inductor to tune a high frequency in the dual frequency band, the first capacitor being connected in parallel with the inductor; or
adjusting a second capacitor to tune a low frequency in the dual frequency band, the second capacitor being connected in series with the first capacitor and the inductor.
